(19) United States
(12) Patent Application Publication
(10) Pub. No.: US 2002/0178113 A1
(43) Pub. Date: Nov. 28, 2002

(54) System and method for offering customized credit card products

(76) Inventors: Jeremy P. Clifford, Arlington, VA (US); Nathan T. Czyzewski, Arlington, VA (US); Kristi S. Hebner, Mechanicsville, VA (US); Michael T. Anderson, Washington, DC (US); Hilary Rhodes, Washington, DC (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/838,194

(22) Filed: Apr. 20, 2001

(51) Int. Cl. G06F 17/60

(52) U.S. Cl. 705/39; 705/36

(57) ABSTRACT

A system and method is provided for offering and providing custom credit card products. The disclosed system and method involve receiving information from an applicant, and processing the information to determine the eligibility of the applicant for a credit card product. If the applicant is found to be eligible to receive the credit card product, then the applicant is asked a few questions. Based on the additional information the applicant is offered an original credit card product. The applicant is provided at least one of a plurality of options concerning the original credit card product. Based on the values selected by the applicant corresponding to each one of the plurality of options provided to the applicant, the applicant is offered a custom credit card product.

### BACKGROUND OF THE INVENTION

I. Field of the Invention

The present invention is related to financial products, such as credit card products and to systems and methods for offering and providing such products. More particularly, the invention relates to systems and methods to offer customized credit card products.

II. Background and Material Information

Credit card products have become so universally well known and ubiquitous that they have fundamentally changed the manner in which financial transactions and dealings are viewed and conducted in society today. Credit card products are most commonly represented by plastic card-like members that are offered and provided to customers through credit card product issuers such as banks and other financial institutions. With a credit card product, an authorized customer or cardholder is capable of purchasing services and/or merchandise without an immediate, direct exchange of cash. With each purchase, the cardholder incurs debt which the cardholder may thereafter pay upon receipt of a monthly or otherwise periodic statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred.

The spending power of a credit card product (i.e., the total amount of funds available to the cardholder at any particular time for making purchases) is typically limited to a particular amount predetermined by the issuer of the card. This amount is commonly referred to as the “credit limit” of the credit card product. The size of the issuer-imposed credit limit is generally based on a number of non-exclusive factors, the most important of which are often the cardholder's earning capacity and the cardholder's credit history. When purchases are made or debts incurred with the credit card product, the available portion of the credit limit is reduced by the purchase or debt amounts. In addition, interest and/or finance charges are also subtracted from the available portion of the credit limit on a periodic basis. The total debits on a credit card product are referred to as the “outstanding balance”, while the remaining or available balance of the credit limit is typically called the “available balance” and reflects the dynamically adjusted current spending power of the credit card product. The cardholder may increase the available balance up to the credit limit, by paying to the issuer (or its representative) the entire outstanding balance or a fractional portion thereof.

Credit card product offers are typically sent to potential customers via regular mail. The issuer of a credit card product may offer potential customers a particular credit card product by disclosing the terms and conditions of the credit card product (e.g., annual fees, interest rate(s) and finance charges, etc.) and the credit limit of the credit card product that may reach a stated maximum upon qualification. When a credit card product application is returned by a customer, the amount of the credit limit is generally determined by the issuer based on various factors, such as the customer's credit history and earning capacity.

Although credit card products are offered based on the above factors, a particular customer's needs and preferences are not considered when issuing a credit card product. For example, some customers may be willing to pay a monthly fee as long as they receive a lower interest rate on their credit card product. On the other hand, other customers may want to pay a per transaction fee. In addition to preferences regarding fee arrangements, customers may have preferences concerning the type of rewards they may be interested in proportion to the usage of their credit card product.

In view of the foregoing, there is presently a need for a system and method for offering and providing customized credit card products to consumers.

### SUMMARY OF THE INVENTION

Systems and methods consistent with the present invention solve the problems associated with inflexible credit card products. Specifically, according to one aspect of the invention, a method for offering and providing a custom credit card product is provided. The method includes receiving information from an applicant and processing the informnation received from the applicant to determine the applicant's eligibility for a credit card product. The method fuirther includes determiining if the applicant is eligible and if so, then receiving additional information from the applicant. Having received the additional information, the applicant is offered a recommended credit card product. Next, the applicant is provided at least one of a plurality of options concerning the recommended credit card product. Based on the values selected by the applicant corresponding to at least one of the plurality of options, the applicant is offered a custom credit card product.

An applicant may be provided with several options concerning a credit card product, consistent with the systems and methods of the present invention. One of the options may be the membership fee associated with the credit card product. Another option may be the credit limit associated with the credit card product. Yet another option may be the annual percentage rate associated with the credit card product. Another option may be the due date on which the payment is due to the issuer of the credit card product.

According to another aspect of the invention, a system for offering and providing a custom credit card product is disclosed. The system comprises means for receiving information from an applicant. The system further comprises means for processing the information received from the applicant to determine the applicant's eligibility for a credit card product. The system also comprises means for receiving additional information from the applicant, if the applicant is found eligible for the credit card product. The system further comprises means for offering a recommended credit card product to the applicant based on the additional information. The system further comprises means for providing the applicant at least one of a plurality of options concerning the recommended credit card product; and means for offering the applicant the custom credit card product, based on the values selected by the applicant corresponding to the at least one of the plurality of options.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which the features of the present invention may be implemented;

FIG. 2 is an exemplary flowchart of a process for offering a customized credit card product, in accordance with the principles of the invention;

FIG. 3 is an exemplary flowchart of a process for customizing a credit card product, in accordance with the principles of the invention; and

FIG. 4 is an exemplary user interface for customizing a credit card product, in accordance with the principles of the invention.

### DETAILED DESCRIPTION

Systems and methods consistent with the present invention solve the problems associated with inflexible credit card products. Specifically, the systems and methods consistent with the present invention enable one to offer customized credit card products. Based on a simple application process, a potential customer's credit card product application is approved or declined. If approved, the customer is asked to provide information used to select a particular type of credit card meeting the customer's needs. The customer can then further customize that credit card product. As part of this customization, the customer may customize many of the features associated with a credit card product, including the credit limit, annual percentage rage, membership fee, and payment date. Next, the customer is offered the custom credit card product, which the customer may accept or decline. If the customer chooses to decline the custom credit card product, then the customer is presented with the option of either accepting the original credit card product offer, or the customer may reset the values associated with the custom features and select some other values for each of the custom features.

The above-noted features and other aspects and principles of the present invention may be implemented in various system or network environments to provide automated computational tools to facilitate customization of credit card products. Such environments and applications may be specially constructed for performing the various processes and operations of the invention or they may include a general-purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well known and available to those having skill in the computer software arts.

Examples of program instructions include both machine code, such as produced by compiler, and files containing a high level code that can be executed by the computer using an interpreter.

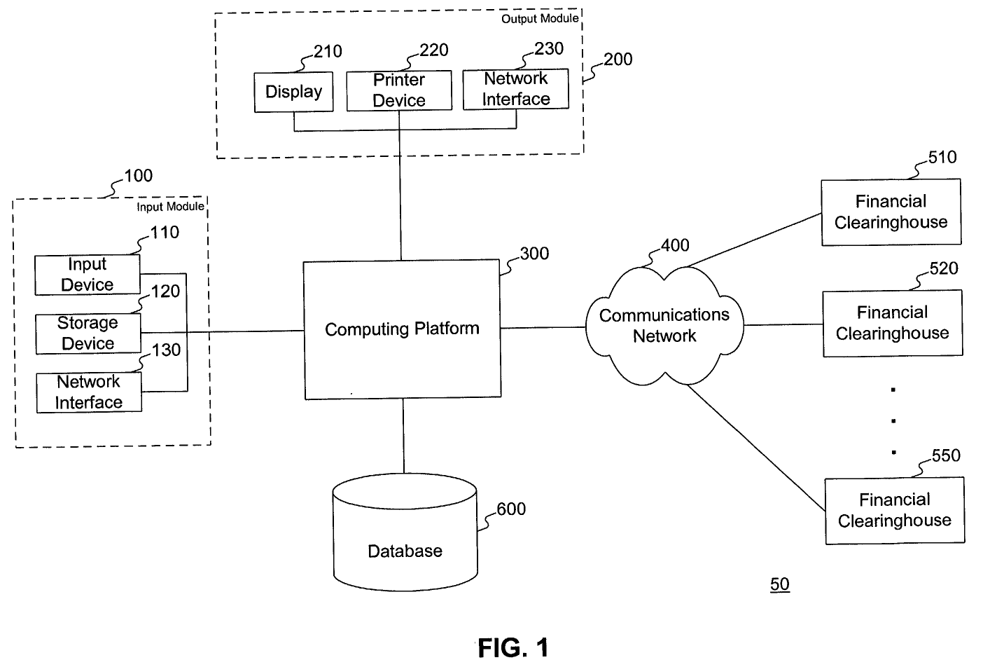

By way of a non-limiting example, FIG. 1 illustrates a system environment 50 in which the features and principles of the present invention may be implemented. As llustrated in the block diagram of FIG. 1, system environment 50 includes an input module 100, an output module 200, a computing platform 300, a database 600, and one or more financial clearinghouses 510-550 that may be accessed through a communications network 400.

Computing platform 300 is adapted to provide the necessary functionality and computing capabilities to analyze each customer's credit history or data provided through nput module 100, or provided from one or more of the financial clearinghouses 510-550 through communications network 400. Credit history information may be accessed and analyzed based on commercially available sources (such as the FICO model from Fair, Isaac and Company, Inc.) and/or through financial clearinghouses 510-550 which may include the one or more of the major credit bureaus such as TRW/Experian, Equifax and TransUnion.

The results from analyzing a customer's credit data are provided as output from computing platform 300 to output module 200 for printed display, viewing or further communication to other system devices. Such output may include an applicant's credit or risk rating, and/or an applicant's potential profitability level. Output from computing platform 300 can also be provided to database 600, which may be utilized as a persistent storage device for storing, for example, new credit card product account information. In the embodiment of FIG. 1, computing platform 300 preferably comprises a PC a or mainframe computer for performing various functions and operations of the invention. Computing platform 300 may be implemented, for example, by a general purpose computer selectively activated or reconfigured by a computer program stored in the computer, or may be a specially constructed computing platform for carrying-out the features and operations of the present invention. Computing platform 300 may also be implemented or provided with a wide variety of components or subsystems including, for example, one or more of the following: a central processing unit, a co-processor, memory, registers, and/or other data processing devices and subsystems.

As indicated above, computing platform 300 communicates or transfers customer and credit data to and from one or more financial clearinghouses 510-550 through communications network 400. Communications network 400 may comprise, alone or in any suitable combination, a telephony-based network (such as a PBX or POTS), a local area network (LAN), a wide area network (WAN), a dedicated intranet, and/or the Internet. Further, any suitable combination of wired and/or wireless components and systems may be incorporated into communications network 400.

Computing platform 300 also communicates or transfers customer and credit data to and from input module 100 and output module 200 through the use of direct connections or communication links, as illustrated in FIG. 1. Alternatively, communication between computing platform 300 and modules 100 and 200 can be achieved through the use of a network architecture (not shown) similar to that described above for communications network 400. By using dedicated communication links or shared network architecture, computing platform 300 may be located in the same location or at a geographically distant location from input module 100 and/or output module 200.

Input module 100 of system environment 50 may be implemented with a wide variety of devices to receive and/or provide the data as input to computing platform 300. As illustrated in FIG. 1, input module 100 includes an input device 110, a storage device 120, and/or a network interface 130. Input device 110 may comprise a keyboard, a mouse, a disk drive or any other suitable input device for providing customer or credit data to computing platform 300. One skilled in the art will appreciate that a customer representative may also receive information from applicants and input that information themselves via input device 110. Memory device 120 may be implemented with various forms of memory or storage devices, such as read-only memory (ROM) devices and random access memory (RAM) devices. Storage device 120 may include a memory tape or disk drive for reading and providing customer or credit data on a storage tape or disk as input to computing platform 200. Input module 100 may also include network interface 130, as illustrated in FIG. 1, to receive data over a network (such as a LAN, WAN, intranet or the Internet) and to provide the same as input to computing platform 300. For example, network interface 130 may be connected to a public or private database over a network for the purpose of receiving and transferring customer or credit data to computing platform 300.

As illustrated in FIG. 1, output module 200 includes a display 210, a printer device 220, and/or a network interface 230 for receiving the results provided as output from computing module 200. As indicated above, the output from computing platform 300 may include credit or risk ratings for potential customers, and/or potential profitability levels for potential customers. The output from computing platform 300 may be displayed or viewed through display 210 (such as a CRT or LCD) and printer device 220. If needed, network interface 230 may also be provided to facilitate the communication of the results from computer platform 300 over a network (such as a LAN, WAN, intranet or the Internet) to remote or distant locations for further analysis or viewing. In either case, the output from output module 200 may be used by the credit card product issuer to generate, for example, internal reports or monitoring.

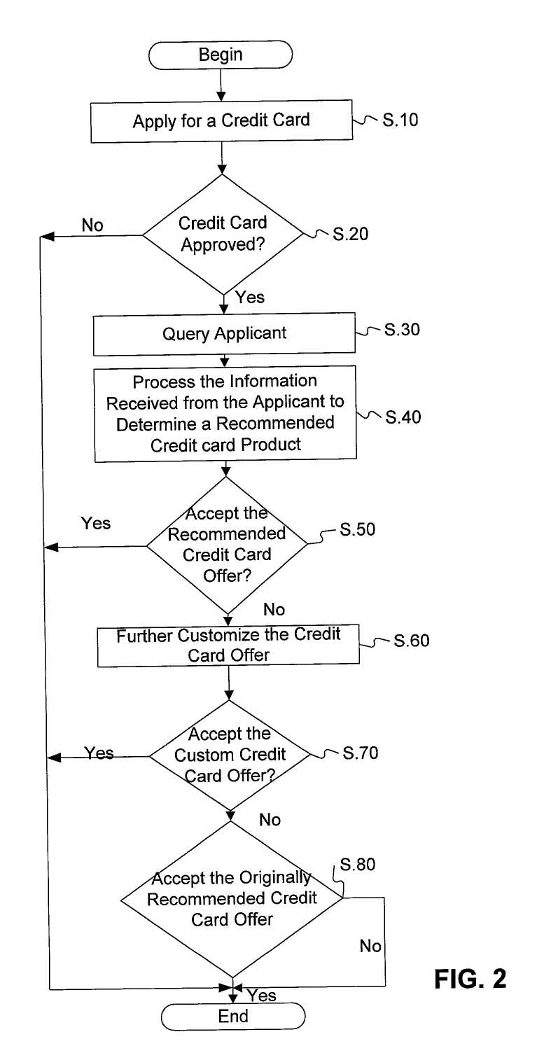

FIG. 2 is an exemplary flowchart of a process for offering and providing a custom credit card product, to an applicant. An applicant first applies for a credit card product (S. 10). Based on the information provided by the applicant as part of the application process, the credit card product issuer determines the eligibility of the applicant for the credit card product. The applicant submits the credit card product application to computing platform 300 via input module 100, which may be connected directly to computing platform 300 or connected through communications network 400. As further described below, the information in the credit card application may be analyzed by computing platform 300 when processing the new account and determining the appropriate credit limit for the customer. An applicant may forward a completed application to the issuer through the mail. Alternatively, applicant information may be received electronically through a communications network (such as communications network 400) or a network interface (such as network interface 130 of input module 100) and may be in the form of an electronic application or message.

One skilled in the art will appreciate that after receiving the application from the applicant, computing platform 300 performs an analysis to determine the actual credit limit for the product offered to the applicant. Information in an application, such as an applicant's full legal name, current address and/or social security number, may be utilized by the issuer in order to gather more accurate and up-to-date data on the applicant's credit history from one or more of the financial clearinghouses 510-550. Thus, the analysis performed by computing platform 300 may use this credit information as well.

Having processed the information provided by the applicant, and if necessary, information from financial-clearing houses 510-550, it is determined whether to issue a credit card product to the applicant (step S.20).

If a credit card product is offered, then the applicant is queried about the applicant's preferences for various features of various credit card products offered by the issuer (S.30). The system can offer different types of credit card products, which can be further tailored to the suit the lifestyle or preferences of a particular applicant. Based on the responses from the applicant, computing platform 300 attempts to determine a recommended credit card product, by analyzing the responses and the preferences expressed by the applicant. For example, the applicant may be asked how often the applicant carries a balance. Another query may prompt the applicant related to the nature of typical use of current credit card products by the applicant. The applicant may also be prompted to provide information as to features of credit card products that most appeal to the applicant. These features may include: (1) convenient and secure online shopping; (2) additional purchase benefits such as extended warranty protection or protection guarantees, which replace an item if lost, stolen, or damaged; (3) travel assistance services, including auto rental coverage, emergency ticket replacement, and medical and legal referral services; and (4) the ability to choose the look of the new card for the applicant. Another prompt may offer a choice of payment due dates to the applicant. The applicant may also be prompted to respond to whether the applicant would like to add an authorized user to the applicant's account.

The questions asked to the applicant in step S.30 may be generated dynamically using various modeling techniques and based on information from the applicant. Thus, for example, based on an analysis of the credit history of the applicant by computing platform 300, computing platform 300 may determine that because the applicant has excellent credit history or a high FICO score, the applicant should be asked more questions concerning his preference for rewards programs. On the other hand, if computing platform 300 determines that the applicant has a poor credit history, then it may ask the applicant more questions related to a secured credit card product that may be offered to the customer. One skilled in the art will appreciate that computing platform 300 may contain other instructions for dynamically generating a variety of queries based on information received about the applicant.

The applicant may be prompted for these responses via several means. For example, the applicant may be presented a prompt via the display of a world-wide-web enabled device, such as a personal computer with a HTTP compatible browser, for example, Netscape Navigator. Using a keyboard, or a mouse, or some other input device associated with this web-enabled device, the applicant provides responses to these prompts for information. These prompts may also be provided to the applicant via a form delivered by postal mail. In that case, the applicant may complete this form and send it to the card issuer. Once the applicant provides information concerning his preferences and other information (S.40), the applicant may be given an opportunity to review his responses. Additionally, a customer representative may use a telephone or a similar device to prompt the applicant and then separately provide the received information to computing platform 300.

Computing platform 300 uses the above preference information provided by the applicant to recommend one of the issuer's various credit card products to the applicant. Additionally, based on the responses to the above questions, the applicant's ability to customize the original credit card may be affected. Thus, for example, where the applicant expressed a preference for a particular payment date, the applicant might not be offered an opportunity to customize the payment date associated with the original credit card product.

Next, the applicant is offered the recommended credit card product and asked whether the applicant wants to accept that credit card product (S.50). Which credit card product to recommend to the applicant may be determined by using several techniques, including for example, rule based modeling techniques or statistical modeling techniques.

Pursuant to the rule based technique, computing platform 300 may keep track of the responses provided by the applicant to a particular query and map each possible response to a particular type of credit card product. Thus, computing platform 300 may receive an applicant's response and recommend the credit card product that is mapped to that response. Alternatively, or in combination with a rule based modeling technique, computing platform 300 may also use statistical modeling techniques to offer a recommended credit card product. For example, by using a known statistical modeling method, computing platform 300 may analyze an applicant's responses to particular queries to develop a probability that the applicant desires a certain feature in a credit card product. By using these probabilities, computing platform 300 can customize a credit card product for offering to the client.

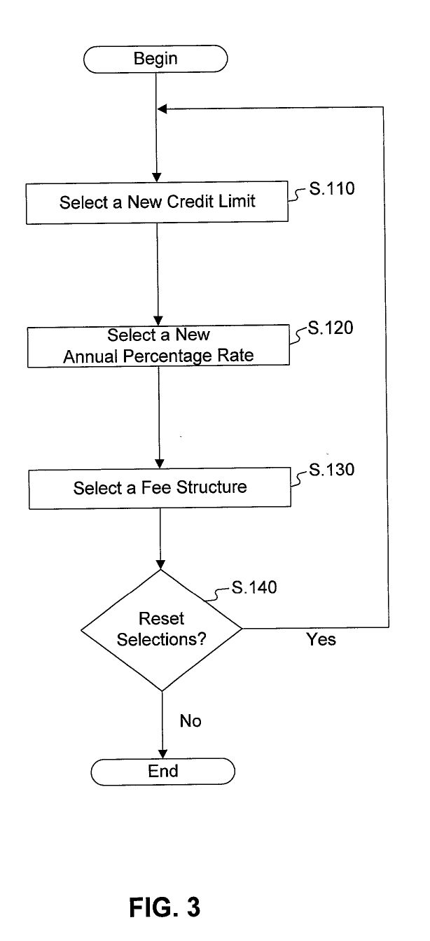

If the applicant does not want to accept the credit card product as offered, then the applicant may customize it using Computing platform 300 (S.60). An exemplary process for customizing the credit card product is described in more detail below with respect to FIG. 3. After completing the customization process, the applicant is offered the custom credit card product (S.70). If the applicant declines the customized credit card product, then the applicant may again be offered the originally recommended credit card product (S.80).

Other implementations of the above process are possible and are within the scope of the claimed invention. Thus, for example, in another implementation consistent with the present invention, in step S.10, the applicant may be queried as in step S.30 above.

Based on the application and the responses to the queries, the system may determine whether to approve a credit card product. If approved, the system may offer a recommended credit card as in step S.40. Subsequent processing may follow the steps outlined above with respect to FIG. 2.

In another implementation consistent with the present invention, where the applicant is approved for a credit card product in step S.20, and provided with a recommended credit card, the applicant may customize the credit card product (as described in step S.60) without responding to queries as discussed with respect to step S.30. One skilled in the art will appreciate that other variations of the above process are possible and are within the scope of the claimed invention. For example, step S.20, in which the applicant is approved for a credit card, may occur later in the process. The applicant may be approved for a credit card product after the applicant has responded to the queries of step S.30. A separate approval process may also be performed after the applicant has completed customizing the offered credit card product.

FIG. 3 depicts an exemplary flowchart for customizing a credit card product. As part of customizing a credit card product, the applicant may customize various features associated with the originally recommended credit card product. The applicant, for example, may select a new credit limit for that credit card product (S. 110). The applicant may also select a new annual percentage rate applied to any outstanding debt (S. 120).

Additionally, as part of this step, the applicant may offer to pay a monthly membership fee in lieu of a lower annual percentage rate. The applicant may also select the type of fee structure associated with the credit card product. (S.130). For example, the applicant may select to pay a per transaction fee or may select to pay a monthly or annual membership fee. Based on the selected fee structure, the applicant may then select a desired fee amount. A person of ordinary skill in the art will appreciate that computing platform 300 may allow the applicant to customize other features associated with the credit card product. For example, the applicant may select a particular due date for making monthly payments to the issuer. Additionally, the applicant may select from the various rewards that may be associated with the credit card product. For example, the applicant may prefer to receive airline mileage, as opposed to store credit for a particular store. Also, the applicant may choose to pay a higher annual fee to receive a wider selection of rewards, or higher amount of rewards. The applicant may reset selections at any time and select different values associated with the options presented to the applicant (S.140).

In addition, in one implementation consistent with the present invention, the ability to customize a particular feature of the originally recommended credit card product is dependent upon selections made by the applicant for other features. For example, if an applicant selects a low annual percentage rate first, then the applicant may not be offered a zero monthly fee. Instead, the applicant's choices may be limited to monthly fees within a predetermined range. Similarly, where the applicant chooses no monthly fee, the applicant's choices as to the annual percentage rate may be limited. The interdependence among the selectable features permits computing platform 300 to create a customized credit card product based on how the applicant prioritizes these features. Computing platform 300 may determine the applicant's prioritization of these features implicitly based on the order in which the applicant customized each features. In another implementation, the applicant may rank each feature by the importance of that feature to the applicant, and thus prioritize the features. Based on the priorities expressed by the applicant, Computing platform 300 may then present the applicant with a customized credit card product incorporating the applicant's feature priority.

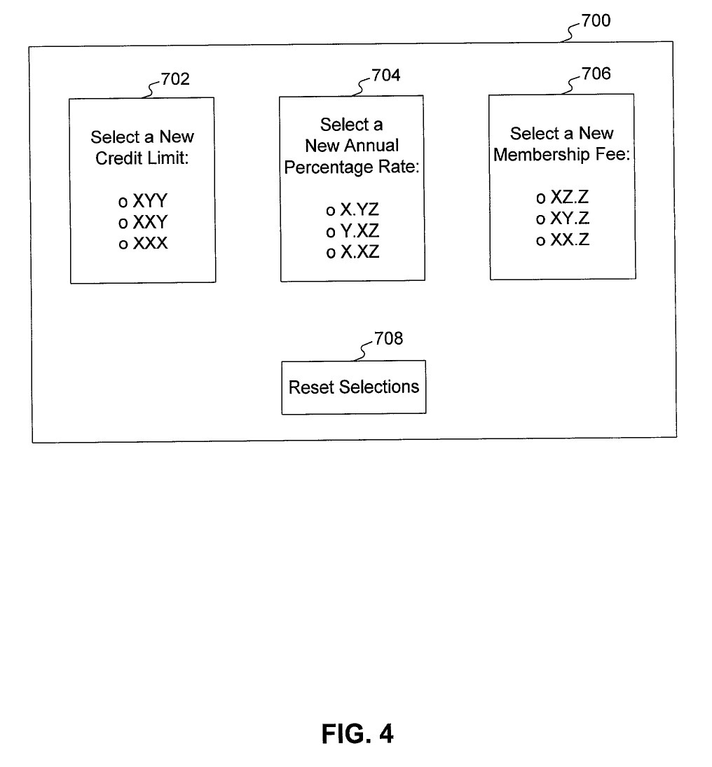

FIG. 4 depicts an exemplary user interface for customizing the credit card product. The exemplary user interface 700 permits an applicant to customize his or her credit card product. As shown in item labeled 702, the applicant may select a new credit limit from among the amounts: XYY, XXY, or XXX, presented to the applicant. As shown in item labeled 704, the applicant may select a new annual percentage rate from the presented annual percentage rates: X.YZ, Y.XZ, or X.XZ. Also, the applicant may select a new membership fee, as shown, in item labeled 706, from among the applicable membership fees: XZ.Z, XY.Z, or XX.Z. The applicant at any time may reset the current selections by selecting a “Reset Selections” user interface element 708. One skilled in the art will appreciate that even though FIG. 4 depicts only three options concerning the credit card product that the applicant may customize, the applicant may be presented with additional or fewer options to customize. Thus, for example, the applicant may also be presented with a selection concerning the due dates on which the applicant wants to make the monthly payments to the issuer or an agent thereof. Additionally, one skilled in the art will appreciate that even though FIG. 4 depicts preset values selectable by the applicant, user interface 700 may also allow the applicant to enter a particular value. Thus, the applicant may input a due date for making the monthly payment as opposed to selecting one from a set of dates that are presented to the applicant. One skilled in the art will appreciate that even though FIG. 4 depicts the options presented to the applicant side by side on a single screen or user interface, these options may be presented sequentially or in other forms.

Other modifications and embodiments of the invention will be apparent to those skilled in the art from consideration of the specification and practice of the invention disclosed herein. For example, the features and aspects of FIGS. 2, 3, and 4 may be implemented alone or in any suitable combination by a credit card product issuer to offer and provide custom credit card products. Additionally, one skilled in the art will appreciate that the systems and methods consistent with the present invention may be used not only to offer customized credit card products, but may also be used to offer customized debit cards, customized secure credit cards, or other related financial products. Therefore, it is intended that the specification and examples be considered as exemplary only, with a true scope and spirit of the invention being indicated by the following claims.

What is claimed is:

1. A method for customizing a financial account product for an applicant, the method comprising:
receiving account preference information from the applicant, the account preference information describing the applicant's preferences concerning various features of the financial account product;
recommending at least one first financial account product to the applicant based on the received account preference information;
providing to the applicant a plurality of selectable options for further defining predetermined features of the recommended financial account product;
receiving the applicant's selected options for the predetermined features of the recommended financial account product; and
customizing the recommended financial account product based on the applicant's selected options.

2. The method of claim 1, wherein the predetermined features of the recommended financial account product selectable by the applicant comprise:
at least one of the following: an annual percentage rate associated with the financial account product, a fee structure associated with the financial account product, and a credit limit associated with the financial account product.

3. The method of claim 1, wherein providing to the applicant a plurality of selectable options, includes:
permitting the applicant to prioritize each of the plurality of predetermined features; and
customizing the recommended financial account product based on the applicant's prioritization of the predetermined features.

4. The method of claim 1, wherein providing to the applicant a plurality of selectable options includes:
determining, for a first predetermined feature, the value of the selectable option for the first predetermined feature based on an option selected by the applicant for a second predetermined feature of the recommended financial account product.

5 . The method of claim 1, wherein recommending the first financial account product includes:
recommending the first financial account product to the applicant based on the received account preference information and based on information contained in an application submitted by the applicant.

6. A system for customizing a financial account product for an applicant, the method comprising:
means for receiving account preference information from the applicant, the account preference information describing the applicant's preferences concerning various features of the financial account product;
means for recommending a first financial account product to the applicant based on the received account preference information;
means for providing to the applicant a plurality of selectable options for further defining predetermined features of the recommended financial account product;
means for receiving the applicant's selected options for the predetermined features of the recommended financial account product; and
means for customizing the recommended financial account product based on the applicant's selected options.

7. The system of claim 6, wherein the predetermined features of the recommended financial account product selectable by the applicant comprise:
at least one of the following: an annual percentage rate associated with the financial account product, a fee structure associated with the financial account product, and a credit limit associated with the financial account product.

8. The system of claim 6, wherein means for providing to the applicant a plurality of selectable options, includes: means for permitting the applicant to prioritize each of the plurality of predetermined features; and
means for customizing the recommended financial account product based on the applicant's prioritization of the predetermined features.

9. The system of claim 6, wherein means for providing to the applicant a plurality of selectable options includes:
means for determining, for a first predetermined feature, the value of the selectable option for the first predetermined feature based on an option selected by the applicant for a second predetermined feature of the recommended financial account product.

10. The system of claim 6, wherein means for reconimending the first financial account product includes:
means for recommending the first financial account product to the applicant based on the received account preference information and based on information contained in an application submitted by the applicant.

11. A computer-readable medium containing instructions for customizing a financial account product for an applicant, the instructions comprising:
receiving account preference information from the applicant, the account preference information describing the applicant's preferences concerning various features of the financial account product;
recommending a first financial account product to the applicant based on the received account preference information;
providing to the applicant a plurality of selectable options for further defining predetermined features of the recommended financial account product;
receiving the applicant's selected options for the predetermined features of the recommended financial account product; and
customizing the recommended financial account product based on the applicant's selected options.

12. The computer-readable medium of claim 11, wherein the predetermined features of the recommended financial account product selectable by the applicant comprise:
at least one of the following: an annual percentage rate associated with the financial account product, a fee structure associated with the financial account product, and a credit limit associated with the financial account product.

13. The computer-readable medium of claim 11, wherein providing to the applicant a plurality of selectable options, includes:
permitting the applicant to prioritize each of the plurality of predetermined features; and
customizing the recommended financial account product based on the applicant's prioritization of the predetermined features.

14. The computer-readable medium of claim 11, wherein providing to the applicant a plurality of selectable options includes:
means for determining, for a first predetermined feature, the value of the selectable option for the first predetermined feature based on an option selected by the applicant for a second predetermined feature of the recommended financial account product.

15. The computer-readable medium of claim 11, wherein recommending the first financial account product includes:
recommending the first financial account product to the applicant based on the received account preference information and based on information contained in an application submitted by the applicant.
